(19) United States
(12) Patent Application Publication
(10) Pub. No.: US 2002/0010005 A1
(43) Pub. Date: Jan. 24, 2002

(54) Method for performing voice dialing through ear-microphone in a mobile terminal

(76) Inventors: Sang-Geun Hwang, Uijeongbu-shi (KR); Oun-Suk Sin, Yongin-shi (KR)

Correspondence Address: Paul J. Farrell, Esq., DILWORTH & BARRESE, 333 Earle Ovington Boulevard, Uniondale, NY, 11553, US

(21) Appl. No.: 09/725,358

(22) Filed: Nov. 29, 2000

(30) Foreign Application Priority Data
Nov. 29, 1999 (KR) 1999-53626
Dec. 3, 1999 (KR) 1999-54733

(51) Int. Cl. H04B 1/38

(52) U.S. Cl. 455/563; 455/66; 455/79; 455/569

(57) ABSTRACT

Voice dialing is performed through an ear-microphone in a mobile terminal with an ear-microphone, having a voice dialing function. The mobile terminal enters a voice dial mode, upon receipt of key data generated by user's pressing a specific key positioned on the ear-microphone, and outputs an outgoing message for performing voice dialing. After outputting the outgoing message, the mobile terminal sequentially demodulates voice data for voice dial phone numbers and outputs the demodulated voice data. The mobile terminal dials a voice dial phone number selected by the user during the output of the voice data.

### PRIORITY

This application claims priority to an application entitled “Method for Performing Voice Dialing Through Ear-microphone in a Mobile Terminal” filed in the Korean Industrial Property Office on Nov. 29, 1999 and assigned Ser. No. 99-53626; and an application entitled “Method for Performing Voice Dialing Through Ear-microphone in a Mobile Terminal” filed in the Korean Industrial Property Office on Dec. 3, 1999 and assigned Ser. No. 99-54733, the contents of which are hereby incorporated by reference.

### BACKGROUND OF THE INVENTION

1. Field of the Invention

The present invention relates generally to a mobile terminal with an ear-microphone, and in particular, to a method for performing voice dialing through an ear-microphone.

2. Description of the Related Art

In general, a mobile terminal may be provided with a voice dialing function. In a voice dialing mode, a user inputs (or utters) a specific voice signal rather than manually dialing a phone number. The mobile terminal then compares the input voice signal with previously stored (or registered) voice signals and automatically dials a phone number corresponding to the registered voice signal identical to the input voice signal. This voice dialing function, however, is very susceptible to problems resulting from surrounding noises. That is, when the surrounding noise increases, the mobile terminal may not correctly recognize the input voice signal and an error in dialing may occur.

As shown in FIG. 2, recent developments in mobile terminals include the provision of an ear-microphone to enable the user to conduct a telephone conversation without using the microphone and speaker included in the terminal itself. Such an ear-microphone 102 includes a speaker 105 for outputting a voice sound, a microphone 106 for receiving an input voice and a key input section 103. The key input section 103 includes a SEND/END key for forming and blocking a communication path.

The ear-microphone 102 is typically used in such a situation where the user drives a car or conducts an important affair, so that he cannot concentrate his attention on the telephone conversation. In this situation, the mobile terminal 101 is generally put in the user's pocket or placed in the car. In this case, in order to conduct a telephone conversation by manipulating a keypad of the mobile terminal, the user must take the mobile terminal out of his pocket or pick it up to perform the corresponding key operation. Alternatively, the user can also conduct the telephone conversation using the voice dialing function, if provided, rather than manipulating the keypad of the mobile terminal. As mentioned above, however, the voice dialing function may erroneously operate due to possible surrounding noises. That is, when the surrounding noises are very significant, the voice dialing function may be rendered useless due to a decrease in efficiency of the memory in which the voice data is stored.

As an alternative, it is also possible to additionally provide the ear-microphone with a plurality of keys such as a voice dial mode enter key and a voice dial search key. However, this inevitably causes an increase in the complexity of the ear-microphone and the number of steps that user is required to perform.

### SUMMARY OF THE INVENTION

It is, therefore, an object of the present invention to provide a method for readily dialing a phone number registered for voice dialing in a mobile terminal with an ear-microphone.

It is another object of the present invention to provide a method for preventing malfunction of a voice dialing function performed through an ear-microphone in a mobile terminal.

It is further another object of the present invention to provide a method for dialing a phone number using voice dial information stored in a voice memory without inputting a voice.

It is yet another object of the present invention to provide a method for dialing a phone number using voice dial information stored in a voice memory even in places where the surrounding noises are significant.

To achieve the above and other objects, there is provided a method for performing voice dialing through an ear-microphone in a mobile terminal with an ear-microphone having a voice dialing function. The method comprises the steps of entering a voice dial mode, upon receipt of key data generated by a user's pressing a specific key provided on the ear-microphone; outputting an outgoing message for performing voice dialing; after outputting the outgoing message, sequentially demodulating voice data for voice dial phone numbers and outputting the demodulated voice data; and dialing a voice dial phone number selected by the user during the output of the voice data.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic block diagram illustrating a mobile terminal with an ear-microphone according to an embodiment of the present invention;

FIG. 2 is a perspective view illustrating a mobile terminal with an ear-microphone according to an embodiment of the present invention;

FIG. 3 is a flow chart illustrating a procedure for performing voice dialing through an ear-microphone according to an embodiment of the present invention; and

FIG. 4 is a flow chart illustrating a procedure for performing voice dialing through an ear-microphone according to another embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

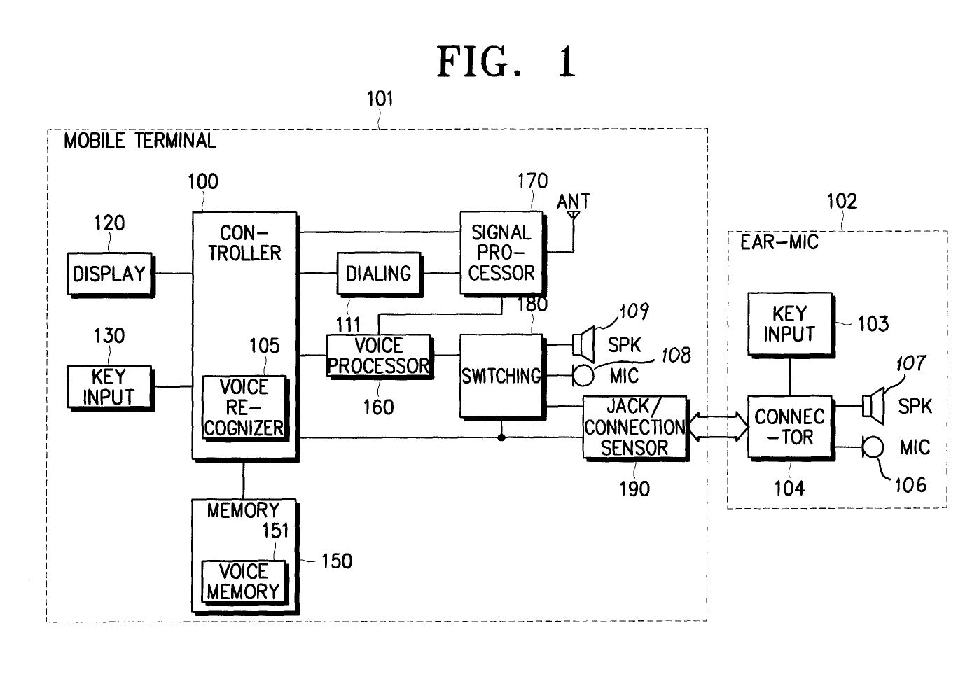

A structure of a mobile terminal with an ear-microphone according to an embodiment of the present invention will now be described in detail with reference to FIG. 1.

A controller 100 controls the overall operation of the mobile terminal 101, including an operation for performing voice dialing through an ear-microphone 102 according to an embodiment of the present invention. A memory device 150 includes a ROM (Read Only Memory; not shown) for storing an operating program, an EEPROM (Electrically Erasable and Programmable ROM; not shown), and a voice memory 151 for storing voice data. A voice recognizer 105, which is included in controller 100, analyzes features of a voice signal input through a microphone MIC (106, 108) and compares the input voice with stored (or registered) voice data. A display 120, preferably an LCD (Liquid Crystal Display), displays a status of the mobile terminal 101 and the progress of the operating program under the control of the controller 100. A key input section 130, such as a keypad, includes a plurality of numeric keys and function keys for performing various functions, and provides key data to the controller 100 according to the user's input key operation. A signal processor 170, under the control of the controller 100, exchanges various data with a base station through an antenna ANT. A voice processor 160 modulates a voice signal input from the microphone MIC (106, 108) into voice data, and demodulates voice data input from the signal processor 170 into a voice signal, which will be output as a voice through a speaker SPK (107, 109). A dialing section 111 dials a phone number under the control of the controller 100. A switching section 180 switches a voice signal path to either the ear-microphone 102 or the speaker SPK 109 and microphone MIC 107 of the mobile terminal 101, depending on whether or not the ear-microphone 102 is connected to the mobile terminal 101. A jack/connection sensor 190, which comprises a terminal for connecting the mobile terminal 101 to the ear-microphone 102, mechanically and electrically detects whether the ear-microphone 102 is connected to the mobile terminal 101. A signal detected by the jack/connection sensor 190 is used to control the switching section 180. A key input section 103 of ear-microphone 102 is used to perform a function of sending or blocking a call (i.e., SEND/END key function) and a scroll key function for scrolling the voice data stored in the voice memory 151. A connector 104 connects a signal output from the ear-microphone 102 to the controller 100 and the voice processor 160 through the jack/connection sensor 190 of the mobile terminal 101.

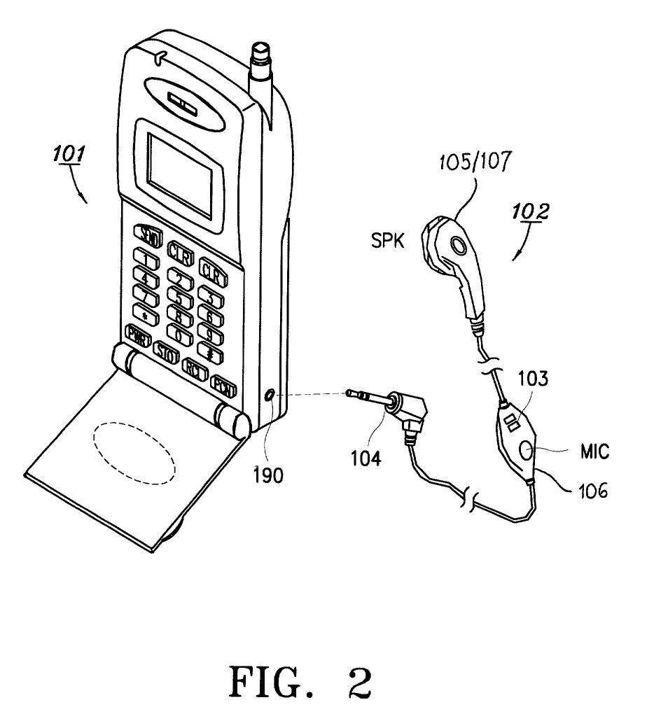

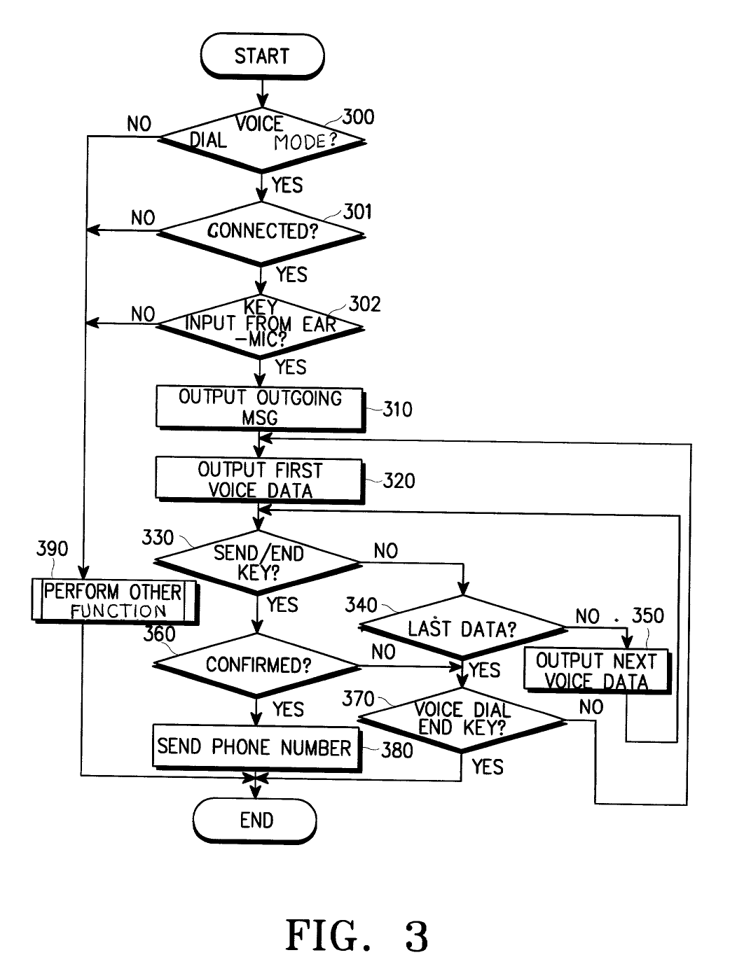

Now, with reference to FIGS. 1 to 3, a detailed description will be made of the operation of performing voice dialing through the ear-microphone according to an embodiment of the present invention.

First, in an idle state, the user sets the terminal to a voice dial mode through the key input section 130 of the mobile terminal 101. Thereafter, if it is determined in step 300 that the terminal is in voice dialing mode, it is determined in step 301 whether the ear-microphone 102 is connected to the mobile terminal 101 through the jack/connection sensor 190. If the ear-microphone 102 is connected to the mobile terminal 101, the controller 100 determines in step 302 whether a key input is received from the key input section 103 of the ear-microphone 102. If any of steps 300, 301 or 302 are answered in the negative, that is if the terminal is not in voice dialing mode at step 300, or if the ear-microphone microphone 102 is not connected to the terminal at step 301, or if there is no key input received at step 302, then the process proceeds to step 390, and some other function may be performed by the terminal, such as normal operation.

Upon receipt of the key input, the controller 100 transitions the mobile terminal 101 from the idle state and then automatically performs the voice dial function, in step 310. At this point, the controller 100 reproduces an outgoing message stored in the voice memory 151 and outputs the reproduced outgoing message through the speaker SPK 107 of the ear-microphone 102. For example, the outgoing message may be “When you hear a desired voice, please press a key”.

In step 320, the controller 100 reproduces first voice data stored in the voice memory 151 and outputs the reproduced voice data through the speaker SPK 107 of the ear-microphone 102. In step 330, the controller 100 determines whether the SEND/END key located on the key input section 103 of the ear-microphone 102 is input (or pressed). If the SEND/END key is not input for a predetermined time, the controller 100 proceeds to step 340. Otherwise, if the SEND/END key is input within the predetermined time, the controller 100 proceeds to step 360 and outputs again the voice data which was output when the SEND/END key is input. Subsequently, the controller 100 outputs a confirmation request message for requesting the user to confirm the selected voice dial phone number. For example, the confirmation request message may be “The phone number you have selected is ‘1112223333’ for John. If it is correct, please press the SEND/END key long”. At this point, if the user presses the SEND/END key, the controller 100 sends the corresponding phone number in step 380.

In step 340, the controller 101 determines whether the output voice data is the last data stored in the voice memory 151. If the voice data is the last data, the controller 110 proceeds to step 370 and otherwise, proceeds to step 350. If a voice dial end key is input in step 370, the controller 100 ends the program and otherwise, returns to the step 320. For the voice dial end key, it is possible to use either a separate key positioned on the key input section 103 or the existing SEND/END key.

In step 350, the controller 100 demodulates the next voice data and outputs the demodulated voice data through the speaker SPK 107 of the ear-microphone 102, and then returns to the step 330.

Next, another embodiment of the present invention will be described in detail. In this embodiment, the controller 100 performs the voice dial function upon receipt of key data generated by the user's pressing the SEND/END key positioned on the ear-microphone 102, and outputs an outgoing message for performing voice dialing. After outputting the outgoing message, the controller sequentially demodulates voice data for the voice dial phone numbers and outputs the demodulated voice data. If the user selects a voice dial phone number by pressing the SEND/END key during the output of the voice data, the controller dials the selected voice dial phone number. A detailed description of this embodiment will be given below with reference to FIGS. 1, 2 and 4.

Table 1 shows, by way of example, the voice data and its associated phone numbers, stored in the voice memory 151.

TABLE 1

| Address | Voice Data | Phone Number |
|---|---|---|
| 1 | John | 111-222-3333 |
| 2 | Headquarters | 222-333-4444 |
| 3 | Silver Bell | 000-000-0000 |
| • | • | • |
| • | • | • |
| • | • | • |

In Table 1, voice data “John” and its associated phone number “111-222-3333” are stored in a first address; voice data “Headquarters” and its associated phone number “222-333-4444” are stored in a second address; and voice data “Silver Bell” and its associated phone number “000-000-0000” are stored in a third address.

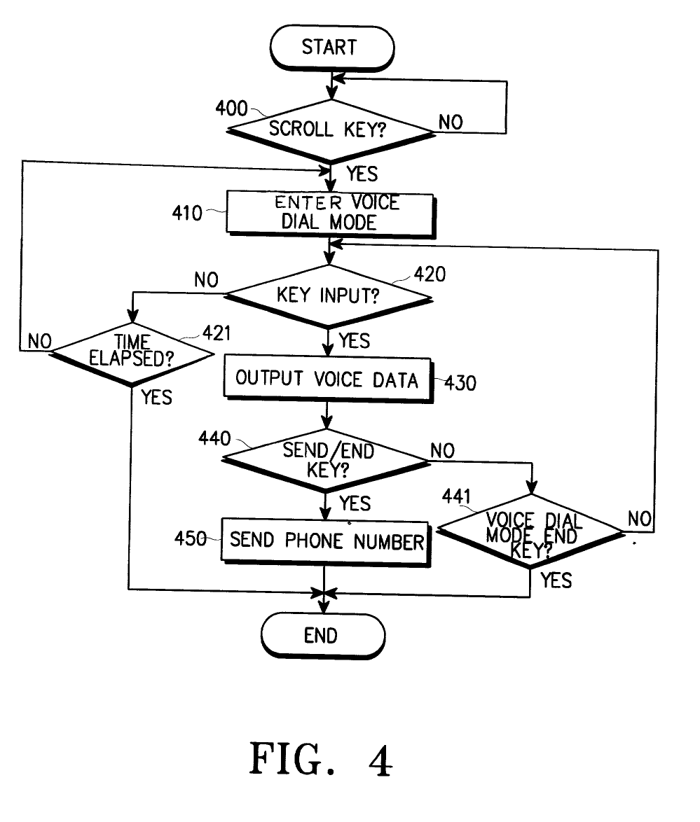

With reference to FIG. 4, the controller 100 determines in step 400 whether a scroll key input is received from a scroll key positioned on the ear-microphone 102. Upon receipt of the scroll key input, the controller 100 proceeds to step 410. The scroll key can be implemented by a rotatable circular key or an UP/DOWN key.

In step 410, the controller 100 enters the voice dial mode, and then determines in step 420 whether the scroll key is input (or pressed). If the scroll key is not input, the controller 100 determines in step 421 whether a predetermine time has elapsed. If the scroll key is not input for the predetermined time, the controller 100 ends the voice dial mode.

If the scroll key is input in step 420, the controller 100 proceeds to step 430 where the voice processor 160 reproduces the voice data stored in the first address of the voice memory 151 and outputs the reproduced voice data through the speaker SPK 107 of the ear-microphone 102. Thereafter, the controller 100 determines in step 440 whether the SEND/END key is input to select the output voice data. If the SEND/END key is input, the controller 100 proceeds to step 450 and otherwise, proceeds to step 441.

In step 450, the controller 100 sends the phone number corresponding to the selected voice data. If the SEND/END key is not input in step 440, the controller 100 determines in step 441 whether a voice dial mode end key is input. If the voice dial mode end key is input, the controller 100 ends the voice dial mode, and otherwise, returns to step 420 to receive the next key input. Here, based on the next key input, the controller 100 outputs the voice data stored in the higher or lower address as compared with the address of the previously output voice data. Table 2 below shows, by way of example, the voice data output according to the key input (from the UP/DOWN key) for the case where the voice data is stored in the addresses 0 to 10.

TABLE 2

| Sequence | Key Input | Address of Output Voice Data |
|---|---|---|
| First Key Input | UP | 1 |
| 2 | UP | 2 |
| 3 | DOWN | 1 |
| 4 | DOWN | 10 |
| 5 | DOWN | 9 |
| • | • | • |
| • | • | • |
| • | • | • |

To sum up, the mobile terminal reproduces the previously stored voice data at the user's request, and outputs the reproduced voice data. When the user selects specific output voice data, the mobile terminal dials a phone number corresponding to the selected voice data.

While the invention has been shown and described with reference to a certain preferred embodiment thereof, it will be understood by those skilled in the art that various changes in form and detail may be made therein without departing from the spirit and scope of the invention as defined by the appended claims.

What is claimed is:

1. A method for performing voice dialing through an ear-microphone in a mobile terminal having a voice dialing function, the method comprising the steps of:
entering a voice dial mode, upon receipt of key data generated by user's pressing a key located on the ear-microphone;
outputting an outgoing message for performing voice dialing;
after outputting the outgoing message, sequentially demodulating voice data for voice dial phone numbers and outputting the demodulated voice data; and
dialing a voice dial phone number selected by the user during the output of the voice data.

2. The method as claimed in claim 1, wherein the voice dial phone number is selected by pressing a SEND/END key located on the ear-microphone.

3. The method as claimed in claim 1, further comprising the step of outputting again the voice data which was output when the key is input, if the user inputs a key for selecting a specific voice dial phone number.

4. A method for performing voice dialing through an ear-microphone in a mobile terminal with a voice dialing function, the terminal having a memory for storing voice data and associated phone numbers and an ear-microphone, the method comprising the steps of:
entering a voice dial mode, upon receipt of key data from a key located on the ear-microphone;
outputting previously stored voice data when the user presses the key located on the ear-microphone; and
dialing a phone number corresponding to the selected voice data, when a key for selecting the output voice data is input.

5. The method as claimed in claim 4, wherein the key located on the ear-microphone is an UP/DOWN key.

6. The method as claimed in claim 4, wherein the dialing step comprises the steps of:
(a) outputting voice data stored in a first address when the user presses the key located on the ear-microphone;
(b) dialing, when the voice data is selected, a phone number corresponding to the selected voice data;
(c) outputting, when the voice data is not selected, the voice data stored in a higher or lower address of the previously output voice data according to a key input from the ear-microphone key; and
(d) returning to step (c) when the output voice data is not selected, and dialing, when the output voice data is selected, a phone number corresponding to the selected voice data.

7. The method as claimed in claim 4, further comprising the step of ending the voice dial mode when a key input for outputting the stored voice data is not input within a predetermined time.

8. A method for performing voice dialing through an ear-microphone in a mobile terminal with a voice dialing function, having a memory for storing voice data and associated phone numbers and an ear-microphone, the method comprising the steps of:
reproducing previously stored voice data and outputting the reproduced voice data at a user's request; and
dialing a phone number corresponding to a selected one among the output voice data.
